(19) United States
(12) Patent Application Publication
(10) Pub. No.: US 2019/0047167 A1
(43) Pub. Date: Feb. 14, 2019

(54) CUTTER FOR ROPES AND TAPES

(71) Applicant: Industro International Co., Ltd., Taichung City (TW)

(72) Inventor: Kuo-Chan Huang, Taichung City (TW)

(21) Appl. No.: 15/675,770

(22) Filed: Aug. 13, 2017

(51) Int. Cl. B26B 27/00; B26B 29/02

(52) U.S. Cl. CPC B26B 27/00; B26B 29/02

(57) ABSTRACT

A cutter includes a grip, a sheath, a blade and a magnetic unit. The grip includes two edges. The sheath is transversely formed at and end of the grip. The sheath and the grip are made in one piece. The sheath includes two openings made in a rear edge thereof, on two opposite sides of the grip. The blade is formed with a cutting edge. The blade is substantially inserted in the sheath, with two sections of the cutting edge exposed to the exterior of the sheath through the openings. The magnetic unit is attached to a face of the cutter.

### BACKGROUND OF INVENTION

### 1. Field of Invention

The present invention relates to a cutter and, more particularly, to a cutter for ropes and tapes.

### 2. Related Prior Art

A conventional cutter that includes a body, a relatively hard blade made of tungsten carbide and a relatively soft blade. The blades are connected to two sides of a same end of the body. The relatively hard blade is used to tiles or other relatively hard objects. The relatively soft blade is used to cut plastic plates, wood plates and other relatively soft objects.

A conventional cutter that includes a body 10 for wrapping a blade 20. The body 10 includes a dispensing section 11, a grip 12 and a storage section 13. The dispensing section 11 intersects the grip 12. The storage section 13 is an annular portion with which the cutter can be hung on a hook for example. A front opening is made in a front edge of the dispensing section 11. Two rear openings are made in a rear edge of the dispensing section 11. The rear openings are on two opposite sides of the grip 12. The blade 20 includes a tip 21 and a cutting edge 22. The blade 20 is inserted in the dispensing section 11. The tip 21 is exposed to the exterior of the dispensing section 11 via the front opening. Two sections of the cutting edge 22 are exposed to the exterior of the dispensing section 11 via the rear openings. The tip 21 is useful for cutting tapes that seal boxes. The cutting edge 22 is useful for cutting ropes for example.

The above-mentioned conventional cutters are effective regarding their purposes. However, it is often difficult for a user to them in a massy working environment where they could easily be concealed by paper boxes, cardboards, plastic plates, wood plates or the like.

The present invention is therefore intended to obviate or at least alleviate the problems encountered in prior art.

### SUMMARY OF INVENTION

It is the primary objective of the present invention to provide a cutter that is effective in operation and can easily be found.

To achieve the foregoing objective, the cutter includes a grip, a sheath, a blade and a magnetic unit. The grip includes two edges. The sheath is transversely formed at and end of the grip. The sheath and the grip are made in one piece. The sheath includes two openings made in a rear edge thereof, on two opposite sides of the grip. The blade is formed with a cutting edge. The blade is substantially inserted in the sheath, with two sections of the cutting edge exposed to the exterior of the sheath through the openings. The magnetic unit is attached to a face of the cutter.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is an exploded view of a cutter according to the first embodiment of the present invention;

FIG. 2 is an enlarged partial view of the cutter shown in FIG. 1;

FIG. 3 is a cross-sectional view of the cutter shown in FIG. 2;

FIG. 4 is a cross-sectional view of a cutter according to the second embodiment of the present invention; and

FIG. 5 is a side view of the cutter shown in FIG. 3.

### DETAILED DESCRIPTION OF EMBODIMENTS

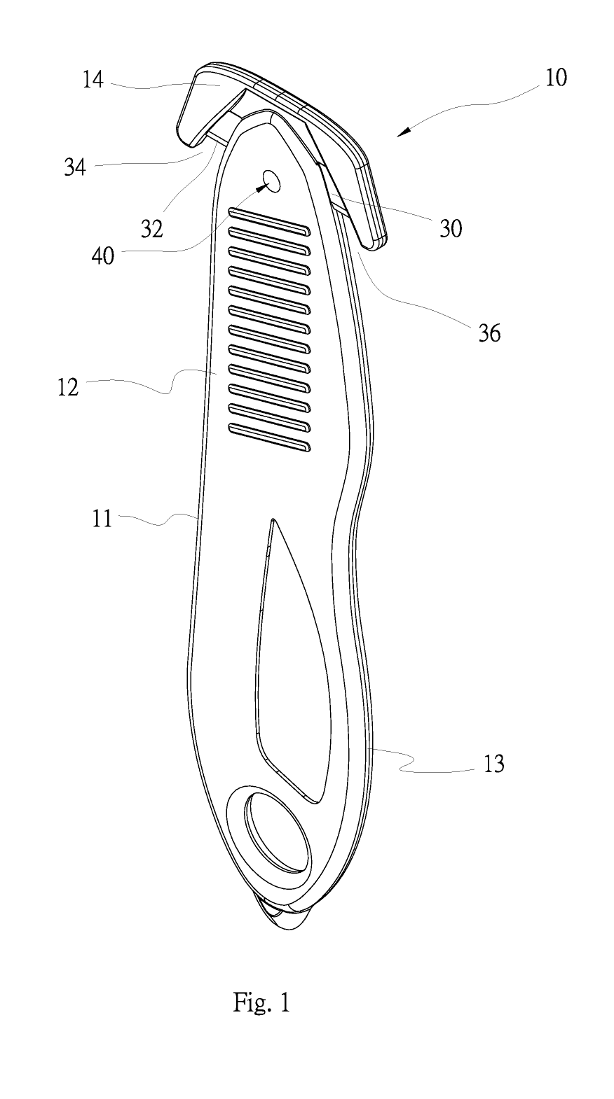

Referring to FIG. 1, a cutter 10 includes a T-shaped handle (not numbered), a blade 30 and a magnetic unit 40 according to a first embodiment of the present invention. The T-shaped handle includes a grip 12 and a sheath 14. The grip 12 extends substantially perpendicular to the sheath 14. The grip 12 and the sheath 14 are made in one piece, i.e., they are two portions of the T-shaped handle.

The grip 12 is an ergonomic element that includes two edges 11 and 13. The edge 11 is in the form of an arc. The edge 13 in the form of waves. In operation of the cutter 10, the edge 11 is in contact with a user's palm while the edge 13 is in contact with the user's fingers. Thus, the user can easily maneuver the cutter 10 to efficiently cut ropes, straps and tapes. Hence, the cutter 10 can be referred to as the “strap cutter.”

The sheath 14 is formed at an end of the grip 12 so that the sheath 14 includes two sections (not numbered) on two opposite sides of the grip 12. The sheath 14 includes two openings 34 and 36. Each of the openings 34 and 36 is made in a rear edge of a corresponding one of the sections of the sheath 14. The opening 34 is located near the edge 11 of the grip 12. The opening 36 is located near the edge 13 of the grip 12.

The blade 30 includes a cutting edge 32. The blade 30 is inserted in the sheath 14 and the grip 12. However, the cutting edge 32 includes two sections exposed to the exterior of the T-shaped handle through the openings 34 and 36. The exposed portions of the cutting edges 32 are used for cutting.

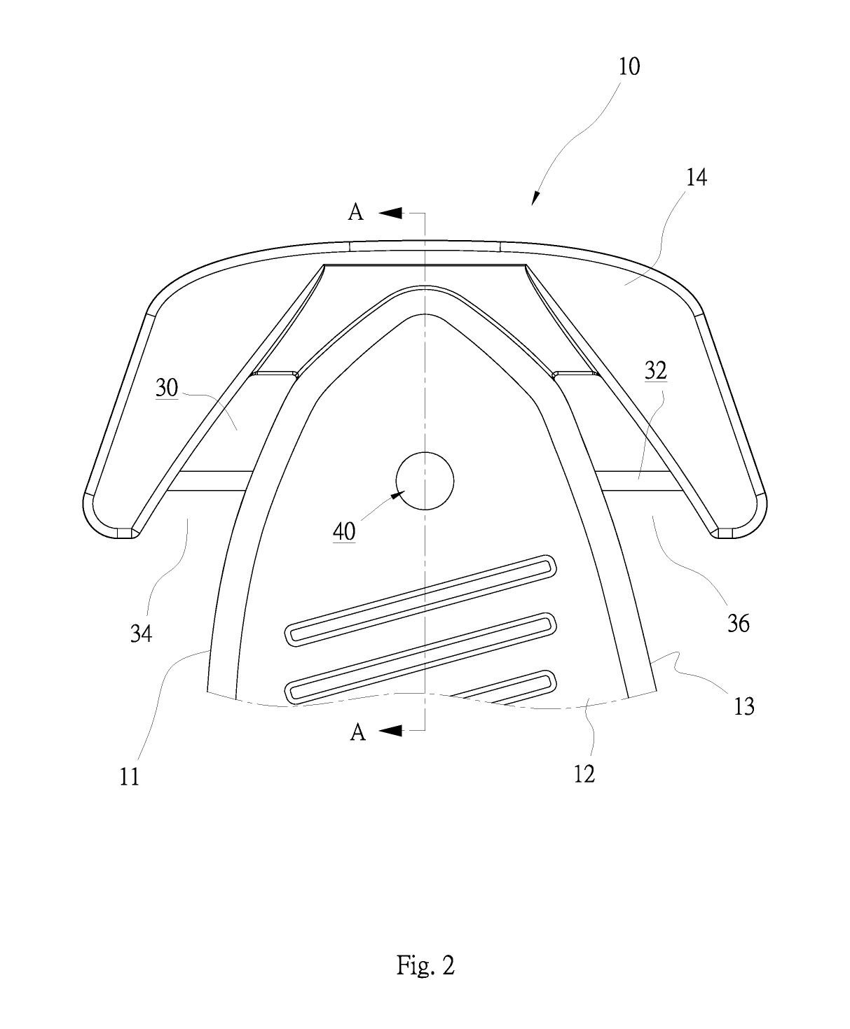

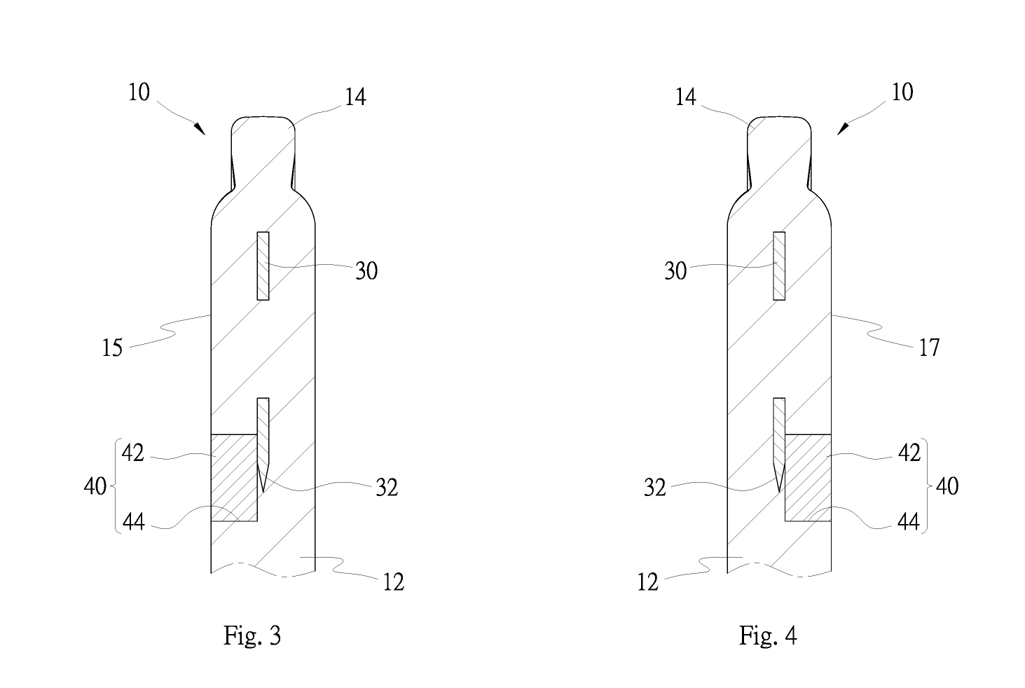

Referring to FIGS. 2 and 3, the magnetic unit 40 is attached to the T-shaped handle of the cutter 10. Preferably, the magnetic unit 40 is attached to a face 15 (or “side”) of the grip 12.

As shown, the magnetic unit 40 includes a magnet 42 and a cavity 44. The magnet 42 is fitted in the cavity 44. The cavity 44 is made in the face 15 of the grip 12. Preferably, an external face of the magnet 42 is flush with the face 15 of the grip 12.

Referring to FIG. 4, there is a cutter according to a second embodiment of the present invention. The second embodiment is like the first embodiment except for that the magnetic unit 40 is attached to another face 17 of the grip 12. The face 17 is located opposite to the face 15. The cavity 44 is made in the face 17. The magnet 42 is fitted in the cavity 44.

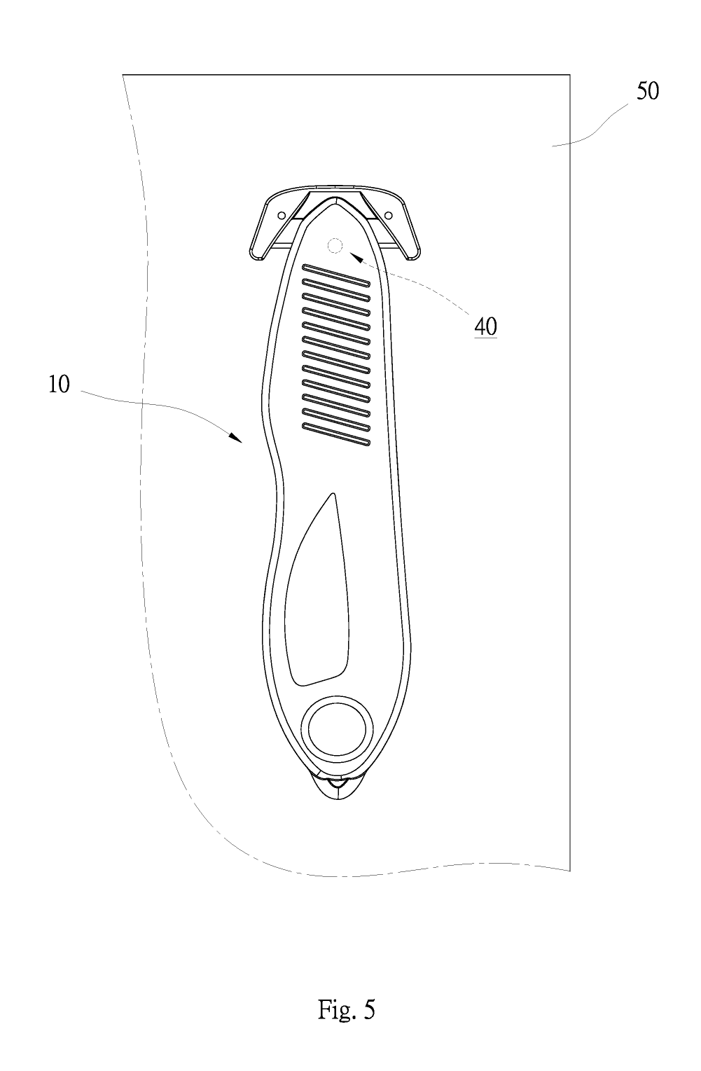

Referring to FIG. 5, the magnetic unit 40 magnetically attracts a ferromagnetic object such as a wall 50 made of a ferromagnetic material. Thus, the cutter 10 is magnetically attached to the wall 50. The cutter 10 can easily be reached.

The present invention has been described via the illustration of the embodiments. Those skilled in the art can derive variations from the embodiments without departing from the scope of the present invention. Hence, the embodiments shall not limit the scope of the present invention defined in the claims.

1. A cutter comprising:
a grip comprising two edges;
a sheath transversely formed at and end of the grip, wherein the sheath and the grip are made in one piece;
two openings made in a rear edge of the sheath, on two opposite sides of the grip;
a blade formed with a cutting edge, wherein the blade is substantially inserted in the sheath, with two sections of the cutting edge exposed to the exterior of the sheath through the openings; and
a magnetic unit attached to a face of the cutter.

2. The cutter according to claim 1, wherein the magnetic unit comprises a cavity made in the face of the cutter and a magnet fitted in the cavity.

3. The cutter according to claim 2, the cavity is made in a left-hand face of the cutter.

4. The cutter according to claim 2, the cavity is made in a right-hand face of the cutter.

5. The cutter according to claim 1, wherein the magnetic unit is attached to a face of the grip.

6. The cutter according to claim 5, wherein the magnetic unit comprises a cavity made in the face of the grip and a magnet fitted in the cavity.

7. The cutter according to claim 6, the cavity is made in a left-hand face of the grip.

8. The cutter according to claim 6, the cavity is made in a right-hand face of the grip.
